(19) United States
(12) Patent Application Publication
(10) Pub. No.: US 2007/0208923 A1
(43) Pub. Date: Sep. 6, 2007

(54) Array Element Mesh System devices for medical, maintenance, and other small form factor applications

(76) Inventor: David Russell, Virginia Beach, VA (US)

Correspondence Address: DAVID RUSSELL, PO BOX 913, VIRGINIA BEACH, VA, 23451-0913, US

(21) Appl. No.: 11/649,898

(22) Filed: Jan. 3, 2007

Related U.S. Application Data
(63) Continuation-in-part of application No. 11/208,250, filed on Aug. 19, 2005.
(60) Provisional application No. 60/755,589, filed on Dec. 31, 2005.

(51) Int. Cl. G06F 15/00

(52) U.S. Cl. 712/22

(57) ABSTRACT

Disclosed is an ultraminiaturized Auto-Locomotive Device (ALD) apparatus with tool actuators and traction, locomotion, and propulsion mechanisms. The ALD is capable of static and dynamic activity, including moving to a target work area or structure, stopping, turning, anchoring, operating ALD actuator tools, auxiliary peripherals, etc., in response to external tactical control commands and/or pre-programmed instructions issued by administrative system(s), and/or “expert system(s)” such as enhanced surgery systems and/or medical robotic systems. The ALD is a specialized version of an Array Element Mesh System (AEMS) adapted for precision control and precision tasks such as in-vitro and in-vivo micromanipulation, microsurgery, transportation of organic and inorganic structures and materials; inter- and intra-cellular navigation, locomotion, and propulsion; surgical procedures and operations; and other very-small tasks. Methods and systems for controlling ALD maneuvers and operational tasks are also disclosed. The present invention is typically used for very-small-geometry, microelectromechanically-executable tasks; cellular-scale surgery; other microscopic techniques; etc.

### RELATED APPLICATIONS

The Non-Provisional Application provided herein claims priority under 35 U.S.C. § 119(e) to U.S. Provisional Patent App. Ser. No. 60/755,589 filed Dec. 31, 2005 entitled, “Array Element Mesh System with Deployable Mini-traction and Locomotion Devices for Medical, Maintenance, and other Small Geometry Applications”. Additionally, this Application is related to—and is a continuation-in-part of—U.S. patent application Ser. No. 11/208,250, entitled “Array Mesh Apparatus, System & Methods” and filed Aug. 19, 2005 (pending), which is included by reference in its entirety.

### BACKGROUND OF THE INVENTION

1. Field of the Invention

The underlying field of the invention is automatic sampling, simulation, and replication of 3D objects, through sampling and robotic technology as implemented in AEMS products. In the present invention, AEMS products are further adapted for medical applications and other very-small form-factor applications. More particularly, AEMS-related inventions disclosed herein can (variously) sample, simulate, replicate, or manipulate within target work areas or structures to do work. In operation, adapted AEMS devices can be controlled to change physical shape, activity configuration, and/or attached working peripherals to expedite micromanipulation, micronavigation, microlocomotion, and/or microsurgery.

Additionally the field of the invention is transportation of organic and inorganic materials, e.g., in-vivo or in-vitro supply or removal of organic cellular material (or other material) for inter- and intra-cellular surgeries, microscopic operations, or other ameliorations medical and non-medical.

2. Related Art

Science Fiction

Fantastic Voyage, a “science fiction” novel by Isaac Asimov, is a story focused on a submarine-like device navigating in a human body, to solve problems. Here, science fiction contemplates in-vivo microsurgery, albeit fancifully. By comparison, the present invention provides distinct features and benefits unanticipated by science fiction, and also provides new or unexpected results.

Nanotechnology Predictions (Circa 1960)

A famous 1960 paper predicting a great future for very-small-geometry applications—There's Plenty of Room at the Bottom, by Richard Feynman, viewable at http://www.zvvex.com/nanotech/feynman.html—page 7, suggests:
“ . . . it would be interesting in surgery if you could swallow the surgeon . . . put the mechanical surgeon inside the blood vessel and it goes into the heart and looks around. Of course the information has to be fed out. It finds out which valve is the faulty one and takes a little knife and slices it out. Other small machines might be permanently incorporated in the body to assist some inadequately-functioning mechanism.”
   Recent Innovative Medical Technology Products

While it has been recently proved feasible to swallow a “surgeon device” for use in the mouth, esophagus, stomach, intestines, etc., there remain many unresolved challenges in the area of intelligent medical devices or robotic devices operating on and/or within animate subjects, such as animal or human bodies.

Obviously, devices will increasingly be introduced at any reasonably-accessible entry point to a body. What we do not see in related art, is technology for precise control, navigation, and locomotion of a device, e.g., to a site in the body where surgery and/or drug delivery is needed, to perform surgical procedures, excise and remove pathology, supply prescription medication, etc.

By contrast, the present invention provides precision-control unavailable in other products known to the inventor. Parent application Ser. No. 11/208,250 provides a basis for AEMS technology. Here, AEMS technology is adapted for precision control. and modularity product modularity.

Illustrative Medical Applications and Other High-Potential Concepts

TV Camera In-Vivo

Regarding in-vivo medical ameliorative therapies, there have been many ambitious endeavors to improve the human condition and address health challenges. For example, researchers created miniature TV cameras and transmitters in the form factor of a pill, which are orally introduced into the human body. Doctors can then receive transmissions of pictures of structures within the body, as the TV camera moves through the body. There are other in-vivo treatments involving the use of television technology, such as flexible sigmoidoscopy.

Balloon Angioplasty In-Vivo

So-called “Balloon Angioplasty” products having very-small-geometry form factors are routinely used to clear arteries and veins near the heart of plaque/debris. Additionally there are other medical ameliorative devices which can be introduced into the human body, such as stents, screws for supporting weak or broken bones, and artificial medical appliance inserts.

Concepts for Other Advanced In-Vivo Devices

In arguably analogous art, Professor Ludwig Bartels has created a new molecule called 9, 10-dithioanthracene (DTA), which can “walk” across a substrate, such as copper, in a straight line. [Phil Schewe and Ben Stein, Walking Molecules, Physics News Update, Number 751 #2, 10/26/2005].

The DTA molecule has two “feet” that are configured in such a way that only one “foot” may rest on the underlying substrate at a time. When the molecule is activated, it will pull up one “foot” and place the other “foot” down, and in this manner can move forward in a perfectly straight line without requiring preset nano-tracks. The molecule can be activated by heat or physical contact, such as a push by the tip of a scanning tunneling microscope. The DTA molecule is intended for use in information storage or computation. Due to the chemical structure of DTA, the molecule can only travel in a straight line, and does not respond to navigational commands.

### NECESSITY OF THE INVENTION

Medical Technology Today

Researchers have succeeded at creating very small form factor in-vivo and in-vitro exploratory and ameliorative medical devices. Such devices are gaining sophistication, and demand is growing for viable products. As discussed above, these technologies enable doctors to view internal workings of the human body, unobstruct veins and arteries, reconstruct broken bones, etc., and accomplish other tasks or procedures.

“Precision” Limitations in Medical Technology

Despite success on many product fronts in medical technology serving many major medical applications, it appears few or no products allow an observer (e.g., doctor, technician) to control micro- and nano-scale movement or surgical procedures in-vivo, using a device which is physically reconfigurable “on the fly” on the micro- or nano-scale.

Unsatisfied Needs

Instantaneous Reconfigurability

The art also appears to lack devices which can alter or transform their physical configuration “on-the-fly” and “as-needed” (e.g., while operating on micro- or nano-scale biostructures; while transporting biomaterial or medication to target biostructures; or while supplying biostructures with medication to ameliorate or fix a target condition, etc.). The art does not appear to contain any precisely-controllable, shape-altering devices that can transport cells and assist the body to work on, ameliorate, or reconstruct itself.

Flexibility, Transport, Delivery

Additionally, the art is very limited with respect to devices that are capable of introducing ex-vivo materials in-vivo, with the exception of hypodermic needles, catheters, and other extant devices now being employed inside the human body.

Target Micro Manipulation and Other Small-Scale Procedures

There's an unsatisfied need for devices capable of acting, manipulating, and/or ameliorating very-small-scale structures or cell-sized materials in-vivo, to help the body to reconstruct or heal itself. For example, such a device could be used to address internal medical conditions, including the precision repair or replacement of damaged neural pathways in the brain. As a case in point, it was recently been demonstrated and photographed, that intercellular communication between neural cells and between immune cells in the human body can be effectuated via intercellular “nanotubes” composed of cellular membrane. (See: Intrigue at the Immune Synapse, Scientific American, February 2006, p. 55). Such an “engineered” pathway (artificially-delivered or artificially-built) could be the physical route and/or dead-reckoning track used by a precision-navigating device which would “morph” or re-configure itself (e.g., from a relatively short, wide device, into an elongated, serpentine 3D object) to adapt itself for travel from neural cell to neural cell, or travel from immune cell to immune cell, or build communications pathways, or any other feasible micro- or nano-scale task.

Accordingly, it appears there's an unsatisfied need in the art for “intelligent”, malleable, flexible, reconfigurable devices capable of introducing ex-vivo materials in-vivo.

### SUMMARY OF THE INVENTION

### Advantages of the Invention

The AEMS is a mathematically-precise device capable of tracking and/or plotting its' steps. Depending on the features implemented in any particular version, it can “morph” (metamorphose, or adapt) itself to pass through restricted places or very small structures structures (e.g., organic membrane nanotubes) based on its configuration and purpose.

In total, the precision control aspects of the invention, including its morphing capabilities as implemented, dead reckoning features, and its “morphability” (which varies, depending on application) all make multiple successful versions of the invention likely.

In the field of reproductive medicine, a version of the present invention could be deployed to improve fertility and increase probability of conception. This device could reduce need for costly in-vitro solutions and/or preclude or limit the use of controversial pharmaceuticals for improving prospects of fertility and/or conception. There also appears to be demand for a version of the device for use in dermatological applications. Additionally, the device could be used topically as a treatment or regimen of innovative cosmetics, e.g., to aid the skin to regenerate itself and eliminate wrinkles, pitting, and other skin conditions caused by sun damage and aging.

Another example of an area where latent demand exists for such a device, is in the amelioration of myocardial infarction. In the highly-variable range of extent of infarction, damage of greater or lesser extent is manifest in an area of scarred heart tissue, i.e., the infarction tissue or dead cells which are the casualty result of myocardial infarction. Such a device could replace and/or export the infarction tissue.

### DETAILED DESCRIPTION OF THE INVENTION

Precision Exploration and Intervention

The present invention discloses a microscopic, mobile, and controllable version of an Array Element Mesh System (AEMS), adapted for use in precision-oriented, organic or inorganic applications, typically for exploration and diverse intervention tasks, such as microsurgeries, micromanipulation, and transport and delivery of materials.

Microscale and Nanoscale Device Dimensions

In one preferred advanced embodiment, the device has microscopic proportions (e.g., sub-1000 nm) so that it may be used in precision-oriented applications (e.g., medical- and/or other small-scale-applications. One with ordinary skill in the art, however, will recognize that the proportions of the device need not be restricted in this manner.

AEMS Devices Adapted for Medical and Other Precision-Control Applications

The small-form-factor version of the AEMS, is based on the original AEMS concept, but further incorporates one or more of locomotion means and/or “course-awareness” of its path in transit; and/or “course direction” to control the direction of its path in transit; locomotion means and/or impeller means; navigation or direction finding and reporting means; tools and/or peripheral actuators; internal and/or external control system means for remote monitoring and control of the device; and possibly a hitch means for linking other devices or auxiliaries.

Diverse Implementation

In alternative embodiments, the device is built as an electronic device or as an electromechanical device; as an organic or inorganic device, as a passive or as an active device; and/or as feasible, based on specific user requirements.

Propulsion and Locomotion

The propulsion and locomotion means of the AEMS-based device permit versions to ambulate on predetermined paths or dynamically-determined paths. In one possible preferred embodiment, the means for propulsion can comprise either traction feet or rollers, which would permit the device to squeeze between cells as applicable or needed for various medical repair, replacement, or amelioration applications.

Location and Navigation

There are various methods used to be certain about the location of the AEMS. One of the methods uses the concept of “dead reckoning” as implemented in the AEMS (e.g., “move x steps on the x-axis; y steps on the y-axis, z steps on the z-axis”). This allows it to precisely track its movements and/or be precisely tracked. In this way, the device can track its steps. The location where the device enters the target (a body or other target object) is referred to as the origin location or zero location (place of embarkation). When the AEMS keeps track of its location, and/or reports its location to an external control system, it becomes easy to control by a doctor or technician.

This is not to be confused with the concept of the AEMS device “zero state”, wherein the AEMS is implemented (“flat” (essentially 2D). An “initialization state” can be any initial state (or configuration) of a device (not just flat).

Regarding location and navigation within a body, the doctor can watch and/or listen (using monitors and stethoscopes) to watch the deployed device's progress as it transits a body or other target object. Also simultaneously the device can “count steps” while it proceeds toward any destination inside a target object. Between what the doctor sees and controls, and the device itself “counting steps” and feeding back data (if provisioned to do so), we can calculate where the device is within the target body or object, in X, Y, and Z planes, on an instantaneous basis.

Radiolocation, Using “Triangulation”

Separately, navigation and direction finding using triangulation apparatus is illustrated: the device is inserted (e.g.) into a human to do knee microsurgery. At the kneecap, or the AEMS insertion point (the AEMS zero location), a plurality of static monitoring devices (3-4) can be deployed on the zero location skin surface. These radiodomes are placed around 360° of an approximate circle or ellipse perimeter. Using 4 radiolocation devices, with one transceiver at each 90°. The transceivers are skin-surface-deployed monitors that listen for device beacons (radiolocation signals) transmitted by the inserted AEMS device(s). “Skin Surface Monitor Transceivers” triangulate to get a fix on the moving device within the target body or object. The doctor or technician can observe a video display (e.g.) connected to the external control system (if provisioned). The device carefully tracks all steps in terms of x, y, and z axis steps . . . it knows where it is located, if provisioned to do that. Also, “navigation” per se is a relative term. Even if the device knows exactly where it is AND the doctor or tech knows where it is . . . the device still might not be exactly on the work area target objective it is sent to fix . . . e.g., repair a knee tendon. Or the device may be moved into the wrong part of a target work area.

Tool Actuators

The tool actuators, depending on explicit implementation and configuration capabilities, permit ALDs to perform predetermined or dynamically determined actions. For example, the actuator tools may allow the ALD to perform different programmed tasks, such as penetration of the body of the subject by piercing and/or cutting, destruction of unwanted cells, or the deployment of replacement cells.

Let's say that in our knee operation, the admin system, and the Bug, and the doctor all agree that the Bug is in the right place to insert some undifferentiated embryonic stem cells into the area of scarring or broken tendons in the subject's knee. The one or more AEMS Bug(s) in there first extend the embedded injector(s) and flow out the stem cells into the area. Let's say there are some obstructions in the area of the site where the new stem cells are to be inserted.

The bug will determine it has to clear an area of obstructions (get out the micro scalpel) and machete-away the interfering or dead tissue. Some versions of the bug might have minilasers that can evaporate the target obstruction. Other versions of the bug might have an excavator tool that dredges out some obstruction and processes it for evaporation or exportation.

Control Systems

The administrative and control system means allow ALDs (Auto Locomotive Devices) and LDs (Locomotive Devices) to be optionally controlled either by external control signals and/or by preprogrammed autonomous control signals from an internal microprocessor or microcontroller. For example, an external control person, typically a doctor or medical technician (or in some applications, an “expert system”), can preprogram device movements and actions and monitor ongoing movements and actions, permitting instantaneous course corrections and enroute activities as needed.

[NB: Use of the term “ALD”, the term “LD”, and the phrase “ALD” and/or “LD” are summarized by the shorthand term “ALD”. When “ALD” is written, it equally means “ALD”, “LD”, and “ALD” and/or “LD”, for brevity sake.]

Transformation

Alternatively, the ALD may transform its physical configuration in response to internal control signals. For example the ALD may transform its' shape from that of an insect-like “Bug” into the shape of a serpentine-like “Snake” of very small diameter in comparison to its length . . . e.g., the ALD could make a snake of the cylindrical dimensions of 20 microns by 200 microns (a 1:10 ratio of width to length).

In one embodiment of the invention, the administrative and control means may additionally comprise one or more imaging means to detect the position of ALDs on or inside the target subject. In various embodiments of the invention, the imaging means may be computed tomography (CT), magnetic resonance imaging (MRI), or positron emission tomography (PET). In one preferred embodiment, the imaging means comprises the 3D Body Holographic Scanner technology recently developed at Pacific Northwest National Laboratory (PNNL), which is capable of detailed high-speed 3D imaging. The administrative and control system may alternatively be analogous to a type of 3-D radar, or use existing tactics from in nuclear medicine and the like, such as effectuating the dyeing and/or radioactive tagging of structures inside the body so their progress can be monitored externally. The administrative and control system can also be interconnected into a medical expert system, a developed or increasingly being developed Artificial Intelligence Medical Expert System.

Finally, the hitch means allows an ALD to connect to another ALD. In one embodiment, the hitch may be comprised of micromechanical means physically linking one ALD to another. In an alternative embodiment, the hitch means may polarize the ALD, such that the “negative” pole of one ALD electromagnetically connects to the “positive” pole of another ALD.

There may be no physical hitching means required or even necessary. Maybe I should be claiming an ALD device of specifiable dimensions . . . maybe multiple deployment of multiple Bugs would for some applications be better than an ALD train . . . which might not make sense from the optimization standpoint, even if it would be superficially apparent to be the most efficient and effective. Maybe if multiple Bugs could be dispatched either at the same time, or separately, they could be capable of rejoining into a train but would not necessarily do so. Ideally much of the intelligence needed to drive and monitor the Bug would be in the admin control system . . . it would be easier in some options and asks less head scratching to contemplate feasibility of an ALD train.

Using the hitch means, two or more ALDs may be connected to accomplish one or more target objective(s) undertaken upon or within target work areas (hereinafter referred to as an “ALD train.”). The details of ALD train composition are configured on a case-by-case basis, depending on the work the ALD train is expected to do. ALD trains will generally be mass-designed and mass-assembled, with further customization depending on target requirements. ALD trains can be assembled during their manufacture or intelligently fabricated dynamically. ALD trains can also be chemically assembled, e.g., in a liquid colloidal dispersion. The ALD train can dynamically change its physical dimensions or characteristics, by connecting or disconnecting ALDs, to suit changing mission needs while underway toward a work area or work objective.

External controllers or system administrators or operators, such as a doctor or a technician, may exercise control over the ALD train as a whole, or may elect to control each ALD in the ALD train separately (i.e., detach one or more ALDs in the ALD train, to be deposited by or jettisoned from the train). These examples notwithstanding, ALDs do not need to be linked in a linear fashion, but could be linked in such a way as to create a 2-D or 3-D structure.

The ALD can be configured and implemented in a variety of user-specified embodiments, such that it performs one or more specialized functions. One typical ALD is the “locomotive/navigation ALD” (LN-ALD), which is a self-controlled preprogrammed ALD, typically used to propel itself and one or more ALD trains along a specified or calculated path to reach a target work area or target objective area.

An alternate specialized ALD is the “payload ALD” (P-ALD), which further includes a means for containing and/or supporting extrinsic matter, such that the ALD can transport the extrinsic matter within the target. The means may include a platform, tank, bin, etc. to transport the matter. Alternative structures are anticipated, depending on the nature of the extrinsic matter. The P-ALD can be used, for example, to transport organic matter such as particular molecules, amino acid chains, DNA sequences, etc. The P-ALD may also be used to transport micromechanical equipment, including—but not limited to—cameras, stents, or other devices.

An alternative embodiment of the ALD further includes a “control tail,” (essentially, a guide wire) which is a structural and/or umbilical means for coupling to a larger instrument (such as a surgical tool). The control tail is connected to the administrative 26 and control system means as well as the hitch means of the ALD, so that the ALD or ALD train may be controlled in response to signals from an external source, such as a doctor. One or more of a scanning tunneling microscope (STM) and/or an atomic force microscope (AFM) can be used to actuate the control tail.

The present invention has many possible applications. For example, the invention can be used to import new, healthy mitochondria into cellular arrays. Mitrochondria can be either “healthy” or “unhealthy”, which directly corresponds with the state of health of the subject's body.

The present invention may also be used to import and/or replace and repair damage to intercellular structures, such as damage caused to neural pathways in the brain by head trauma. Neural damage vastly affects an individual; as one example, if neural structures in the cerebellum are damaged, the individual's balance, movement, and coordination are affected. For example, to restore or improve “balance”, repairs that may be needed may be establishing or improving “balance” by allowing proprioceptor signals from the inner ear to be transmitted from the inner ear to the balance center in the brain. From the perspective of the balance center in the brain, “balance” in the human body is largely a combined function of gravity, direction, speed, momentum, mass, and other factors.

Similarly, the combination of balance, movement, and coordination may be improved if, e.g., the proprioceptor signals and the neural pathways in the brain that they feed can be reconnected and/or amplified. In the case where proprioceptor signals are not getting through to the balance center in the brain, e.g., it may be necessary to repair damaged areas and/or replace signal carrying capabilities in structures which run from the proprioceptors in the inner ear to the balance center in the brain.

When signals are not getting through normal pathways, it is necessary that existing proprioceptor signal relays are bypassed with new signal relays.

In the case of a job to repair a myocardial infarction, the specific ALD trains can be configured with P-ALDs, which can be implemented in target locations, such as the site of a myocardial infarction (scar which forms after some heart attacks). In the process of the perambulation of the ALD to ameliorate the myocardial infarction, the system of the myocardial infarction amelioration includes (1) external monitoring and control instruments operated by a doctor and (2) ALD trains adapted for myocardial infarction remediation. To establish a remediation operation, first the area of the infarction is precisely mapped. Based on the size of the area to be repaired, the number of ALD trains needed for the repair is calculated. A number of ALD trains of predetermined sizes and complements are estimated. The trains are configured to include P-ALDs, which carry: organic scaffold materials and deposition tools for depositing the scaffold on the target remediation site, beating myocytes, and drugs and/or cellular nutrients.

In one embodiment of the invention, the ALD is implemented as an electromechanical device. The administrative and control means may comprise a microprocessor, which can process and execute control signals, and an electronic transceiver, allowing the ALD to receive control signals from other ALDs or external sources. The means for self-propulsion is coupled to the microprocessor, such that it can respond to control signals received from the processor. The means for self-propulsion can receive commands from the microprocessor chip relating to the velocity—both speed and direction—of the means for propulsion; this allows the microprocessor chip to steer the ALD. The ALD also includes a power source, which is connected to the microprocessor and permits the ALD to operate. In various preferred embodiments of the invention, the ALD may receive power through the transceiver in the form of external electromagnetic excitation, may possess a fully self-contained power source, or may consume body fluids of the individual host.

The present invention further discloses methods and systems for controlling and administering the ALD. The administrative system allows doctors, medical assistants, or other individuals to control the velocity of the ALD, as well as tool deployment and tool activation. The administrative system comprises an administrative computer, a means for communication, and one or more ALDs. The administrative computer is a standard computer terminal, allowing individuals means to input commands and view data. The administrative computer is attached to the means for communication, which allows the administrative computer to communicate with the ALDs. In the case of electromechanical ALDs, the means for communication in the administrative ALD may be an electromechanical ALD. There are multiple different ways to communicate with organic devices, some involving transmission of intelligence; others simply using “brute force” methods of communication. In this manner, a doctor may use the administrative computer to control the ALDs.

Applications: Inner Ear Cilia Replacement

Insertion into the AEMS Zero Location

An AEMS adapted for facilitating inner ear surgery is commanded to replace ear cilia into the inner ear. We have the lead LN-ALD and one or more P-ALDs introduced by the doctor into the subject's ear canal. That point of insertion is the “AEMS zero location”. The doctor or tech monitors (and tweaks if needed) the path of progress from the ear canal entry point, the zero location into the inner ear. The device crawls along the ear canal to its target destination within a target object. Alternatively, the doctor injects the devices beneath the inside skin of the inner ear canal.

Malfunctioning Inner Ear Cilia

To illustrate a practical example, the problem is that the target object person's inner ear cilia are malfunctioning—either atrophied or non-responsive due to chronic exposure to loud low-frequency noise (like years in the engine room of a large ship).

Importation, Transport, and Delivery

The invention hauls in a “P-ALD” load of new cilia and/or inner ear goop. The invention could also haul in embryonic stem cells. But in this case the importation of cilia into an inner ear could be re-usage of cilia from the subjects ear which has extra cilia in it due to no damage . . . in this case the Bug would not only be used to INSTALL new cilia into the inner ear . . . but would also be used to EXTRACT a graft of functioning cilia from the subject's own undamaged ear . . . or ear area less damaged.

We have not yet determined whether undifferentiated embryonic stem cells can “make cilia” (or other specialized structures). The limits of embryonic stem cells are currently the subject of the inventor and many other researchers as well. Possible downstream applications could include one or more of bone marrow transplant and renovation applications; reproductive medicine applications; knee (joint) application; floater retrieval from aqueous humor of the eye or other eye surgery applications; and many others. Actuators in general can also be adapted for other extraction/relocation requirements.

Given the human body's predilection for REJECTING things that it does not recognize, e.g., while it is likely that one's brother or sister can provide a person with bone marrow . . . it is NOT likely that bone marrow can be extracted from another who is not closely related to the subject WITHOUT it being rejected in an unrelated subject's body.

Another concept: a “minitest feature”. It can test the miscibility of the (e.g., imported stem cells or bone marrow) with the body . . . i.e., test that the target work area tissue is COMPATIBLE with the potential-to-be-installed tissue (which is carried by the Bug.) Another concept: the analogy of “Epoxy A and Epoxy B” . . . i.e., there are 2 or more devices, each carries a reactant or tissue or some part of the “recipe” needed for the target objective. Chemical reactions can be effected by combining multiple tissues and reactants or chemicals, at the target work area, with the sequential timing as needed to effectuate the objective, or accomplish the mission.

### FIGURES

FIG. 1, AEMS with directional friction

FIG. 2, Magnified area 6 to show teeth that provide directional friction

FIG. 3, AEMS with biocompatible shell

FIG. 4, AEMS beginning transport by magnetic oscillation down outer ear canal

FIG. 5, AEMS proceeding by magnetic oscillation further down outer ear canal

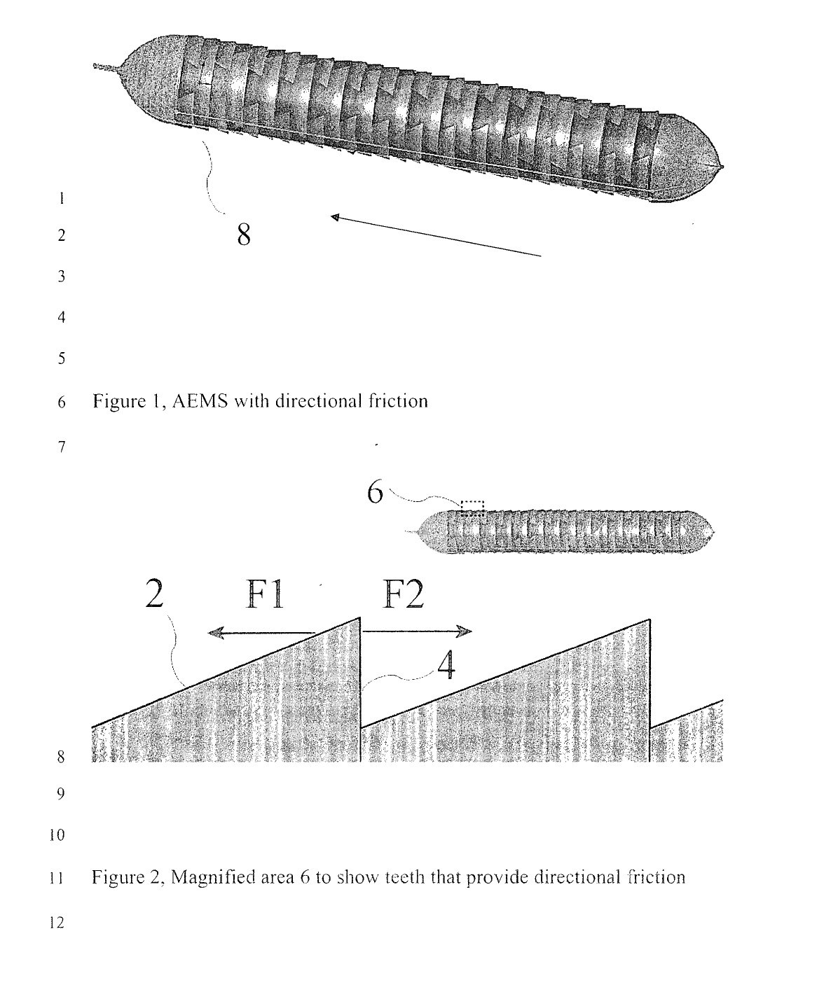

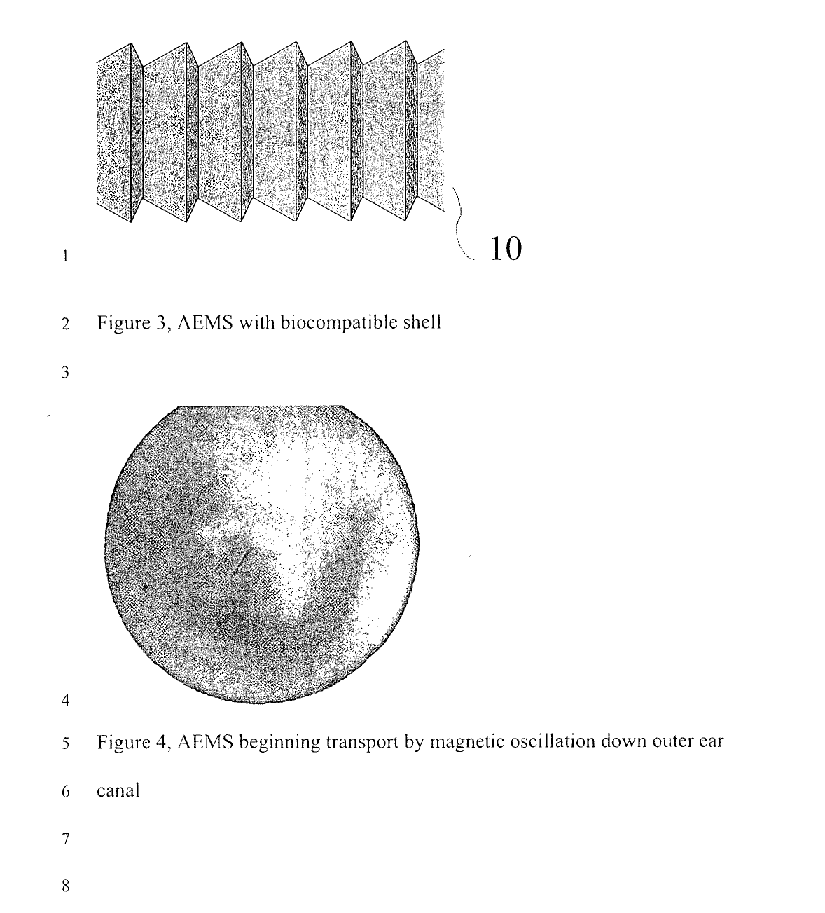

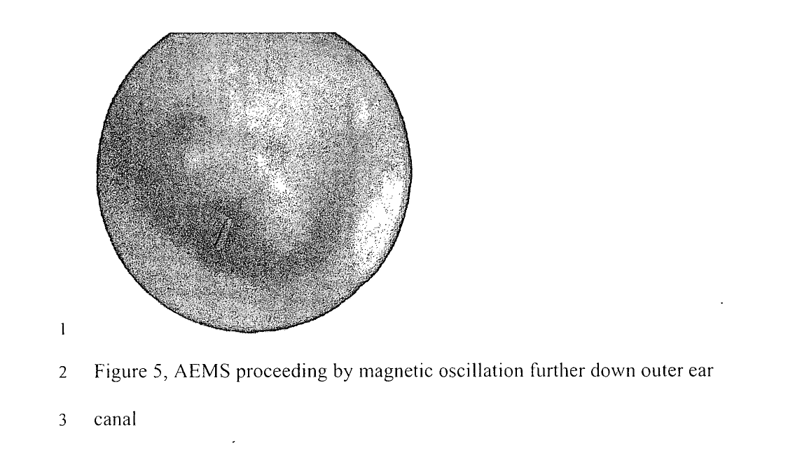

### REFERENCE NUMERALS

2 Gently sloping surface that produces little force F1
4 Steeply sloping surface that produces a stronger force F2
6 Area of stepped surface that is detailed in FIG. 2
8 Complete AEMS unit with ridges
10 Center portion of AEMS unit with biocompatible coating or shell
   Broadening of Meaning:

There are many other implementations possible, which may be different from examples discussed herein, but which are not discussed herein. Accordingly, one skilled in the art will probably see that other combinations and synergies and teaming agreements are likely, without deviating from the spirit of this application for a United States Patent.

We claim:

1. An AEMS apparatus adapted for precision-control applications, comprising:
at least one substrate;
at least one processor;
at least one transceiver coupled to said at least one processor;
at least one of an actuator tool and a means for transporting a payload; and
at least one means for pointing said AEMS device toward a target destination.

2. The apparatus of claim 1, further including at least one of a propulsion means and a locomotion means.

3. The apparatus of claim 1, further including at least one of a power source and a power supply.

4. The apparatus of claim 1, wherein said at least one substrate is comprised of a plurality of array elements integrated to form an AEMS further comprising the body of said apparatus.

5. The apparatus of claim 1, wherein said at least one processor includes instructions for at least one of (but not limited to):
(i) determining apparatus position and determining and extrapolating position changes over time when operating within a target object;
(ii) determining at least one of the relative position of said apparatus and the absolute position of said apparatus when compared to at least one reference point determining distance to a destination within said target object;
(iii) determining instantaneous best path to said destination;
(iv) pointing said apparatus toward said destination within said target object;
(v) communicating to and from at least one external control system; and
(vi) controlling operation of said apparatus including operation of at least one array element in said AEMS in order to do work and in order to direct movement of said apparatus toward at least one said destination located within said target object.

6. The apparatus of claim 1, wherein said transceiver includes means for communicating signals between said apparatus and at least one external control system.

7. The apparatus of claim 1, wherein at least one of a propulsion means and a locomotion means is co-located with said external control system.

8. The apparatus of claim 1, wherein said power supply is external to said apparatus and comprises a source of electrical energy adapted for transmission to said apparatus, and wherein the locomotion and propulsion of said apparatus is precisely controlled by varying the strength and directionality of said electrical energy transmitted to said apparatus.

9. The apparatus of claim 1, further comprising at least one interconnector for connecting to and disconnecting from at least one other AEMS apparatus.

10. An external control system for monitoring, tracking, and controlling propulsion, locomotion, and operation of an AEMS apparatus, comprising:
at least one processor including instructions for monitoring, tracking, controlling, initiating, launching, executing, and terminating propulsion, locomotion, and operation of said AEMS apparatus;
a transceiver for communicating between said external control system and said AEMS apparatus; and
at least one of a monitor connected to at least one computer.

11. The external control system of claim 10, further comprising a linking and tethering system for at least one of communicating with and for controlling locomotion of said AEMS apparatus.

12. The apparatus of claim 2, wherein said at least one propulsion means comprises at least one of traction feet and rollers.

13. The apparatus of claim 12, wherein said traction feet further comprise alternately-facing locomotive feet for moving said ALD apparatus toward at least one of a target work area and a 3D target object and a target destination therewithin, and wherein said alternately-facing locomotive feet are at least one of retractable within said ALD body of said ALD apparatus and extendable out of said ALD body of said ALD apparatus.

14. The apparatus of claim 1, wherein said at least one actuator tool comprises a scalpel actuator tool for piercing and cutting into a target work area.

15. The apparatus of claim 1, wherein said at least one actuator tool comprises a disruptor actuator tool; wherein said disruptor actuator tool is adapted for destroying human organic cellular material; and wherein said disruptor actuator tool is also adapted for destroying animal cells.

16. The apparatus of claim 1, wherein said at least one actuator tool comprises a payload actuator tool; wherein said at least one payload actuator tool is adapted for deploying replacement animal cells.

17. The apparatus of claim 12, wherein said at least one payload actuator tool is also adapted for deploying replacement animal cells comprising replacement human myocytes.

18. The apparatus of claim 12, wherein said at least one payload actuator tool is also adapted for deploying replacement animal cells comprising replacement rodent myocytes.

19. The apparatus of claim 1, wherein said power source is charged through external electromagnetic excitation.

20. The apparatus of claim 1, wherein said power source is a self-contained battery.

21. The ALD of claim 1, wherein said power source is charged through consumption of absorbable bodily fluids integral to an animal subject.

22. The administrative system of claim 22, wherein said wire-connected interface means further comprises at least one control tail coupled into at least one control tail fitting.

23. An ALD train assembly system for interconnecting a plurality of AEMS-ALDs into at least one ALD train, comprising: instrument means for staging and organizing component ALDs prior to assembly of said at least one ALD train; means for selecting and organizing assembly of said component ALDs including at least one of selecting and organizing of an LN-ALD component and a Payload-ALD component; means for further coupling said component ALDs together to assemble at least one ALD train further comprising at least two coupling devices disposed upon at least two control tail fittings of each said component ALDs; means for communicating between said component ALDs comprising said assembled ALD train and further including means for communicating between said ALD train and at least one external control means.

24. The administrative system of claim 23, wherein the means for imaging is at least one of computed tomography (CT) technology; magnetic resonance imaging (MRI) technology; positron emission tomography (PET) technology; and 3D Body Holographic Scanner technology.
